(19) United States
(12) Patent Application Publication
(10) Pub. No.: US 2025/0256685 A1
(43) Pub. Date: Aug. 14, 2025

(54) VEHICLE AND BUILDING ROOF DEICING SYSTEMS

(71) Applicant: Creative Deicing Solutions, LLC, Northford, CT (US)

(72) Inventors: Tyrone W.E. Perez, Northford, CT (US); Geralyn Perez, Northford, CT (US)

(73) Assignee: Creative Deicing Solutions, LLC, Northford, CT (US)

(21) Appl. No.: 19/192,473

(22) Filed: Apr. 29, 2025

Related U.S. Application Data
(63) Continuation-in-part of application No. 17/861,500, filed on Jul. 11, 2022.
(60) Provisional application No. 63/220,705, filed on Jul. 12, 2021.

(51) Int. Cl. B60S 1/66; E04D 13/076

(52) U.S. Cl. CPC B60S 1/66; E04D 13/0762

(57) ABSTRACT

A deicer system for distributing deicer solution along a structure. The deicer system includes a deicing solution reservoir that contains the deicer solution, a pump, and one or more emitters. The pump is in fluid communication with the deicer solution reservoir and the pump is configured to distribute the deicer solution. The one or more emitters are in fluid communication with the deicer solution reservoir and the pump. The one or more emitters are positioned in a housing that is integrally connected to the structure. The one or more emitters are configured to dispense the deicer solution along the structure.

### CROSS REFERENCE TO RELATED APPLICATIONS

This application is a continuation in part application that claims priority to co-pending and commonly owned U.S. patent application Ser. No. 17/861,500, filed on Jul. 11, 2022, which claims priority to U.S. Provisional Patent Application Ser. No. 63/220,705, filed on Jul. 12, 2021, the entireties of which are incorporated herein by reference.

### TECHNICAL FIELD

The present disclosure relates generally to deicing. More particularly, the present disclosure relates to systems for preventing or limiting ice and ice dam formation along and around roof structures.

### BACKGROUND

Residential vehicles and commercial trailer truck vehicles are often on the open road or parked outdoors during snow and ice storms, resulting in the roofs of such vehicles becoming loaded with ice and snow. The increase load of ice and snow decrease the fuel economy of the vehicles and poses a safety hazard during transit as the ice and snow may dislodge and cause traffic accidents involving following vehicles.

An ice dam is a ridge of ice that forms at the edge of a building's roof and prevents melting snow from draining off the roof. The ice dam backs up water that can leak into the building and damage the interior walls, ceilings, floors, insulation, etc.

Thus, there is a need for improved deicing systems that overcome the foregoing problems.

### SUMMARY

According to aspects illustrated herein, there is provided a deicer system for distributing deicer solution along a structure. The deicer system includes a deicing solution reservoir that contains the deicer solution, a pump, and one or more emitters. The pump is in fluid communication with the deicer solution reservoir and the pump is configured to distribute the deicer solution. The one or more emitters are in fluid communication with the deicer solution reservoir and the pump. The one or more emitters are positioned in a housing that is integrally connected to the structure. The one or more emitters are configured to dispense the deicer solution along the structure.

In one embodiment, the structure is a vehicle and the housing is a rack that is integrally connected to a roof of the vehicle. The one or more emitters are configured to dispense the deicer solution over at least a portion of the roof.

In one embodiment, the structure is a vehicle and the housing is integrally connected to a side of the vehicle adjacent a peripheral edge of a roof of the vehicle. The one or more emitters are configured to dispense the deicer solution over at least a portion of the roof.

In one embodiment, the one or more emitters are configured to extend out from one or more openings in the housing over the roof of the vehicle when in a dispensing state, and to retract into the housing through the one or more openings when in a storage state.

In one embodiment, an uppermost portion of the housing is substantially flush with the roof of the vehicle when the at least one emitter is in the storage state.

In one embodiment, the structure is a building and the housing is a gutter system that is integrally connected to one or more sides of the building and one or more peripheral edges of a roof of the building. The one or more emitters are configured to dispense the deicer solution within the gutter system and over at least a portion of the roof.

In one embodiment, the one or more emitters are spray emitters.

In one embodiment, the deicer solution is formed of a biodegradable liquid that is non-corrosive to metal materials.

Any of the foregoing embodiments may be combined.

### BRIEF DESCRIPTION OF THE DRAWING

Referring now to the Figures, which are exemplary embodiments, and wherein the like elements are numbered alike:

FIG. 1 is an isometric view of a deicer system according to an embodiment of the present invention;

FIGS. 2A-2D are a side elevation view, a top plan view, a front elevation view, and a rear elevation view, respectively, of a deicer system according to an embodiment of the present invention;

FIG. 3 is an isometric view of a deicer system according to an embodiment of the present invention;

FIG. 4 is an enlarged view of Detail 4 of FIG. 3, showing a partial cross section of the deicer system taken along section line G-G;

FIG. 5A is a side elevation view of a deicer and snow removal system according to an embodiment of the present invention;

FIG. 5B is an enlarged view of one embodiment of Detail 5A, 5B of FIG. 5A;

FIG. 5C is an enlarged view of another embodiment of Detail 5A, 5B of FIG. 5A;

FIG. 6 is a side elevation view of a deicer and snow removal system according to another embodiment of the present invention;

FIG. 7 is a perspective view of another embodiment of the present invention;

FIG. 8 is a side elevation view of a deicer and snow removal system according to another embodiment of the present invention; and

FIG. 9 is a schematic view of an embodiment of the deicing system including a heat exchanger for heating the deicing solution and/or a gas.

### DETAILED DESCRIPTION

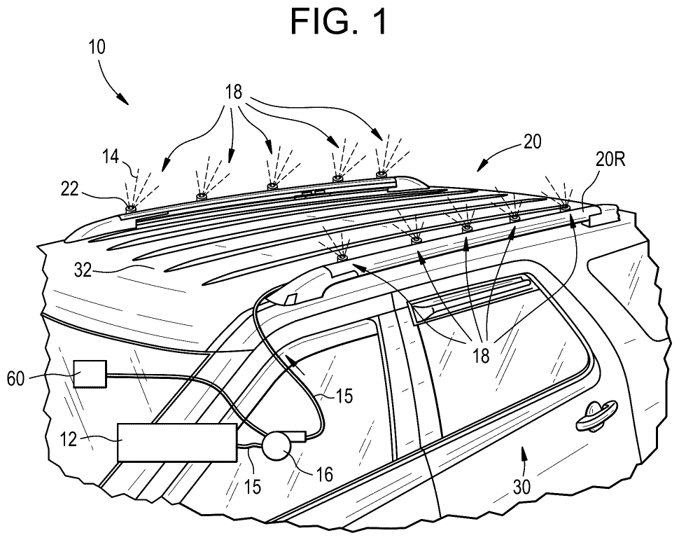

As shown in FIG. 1, a deicer system is generally designated by the number 10. The deicer system 10 includes a deicing solution reservoir 12 that contains a deicing solution 14. The deicing solution 14 is biodegradable, environmentally friendly, and is non-corrosive of metal materials. Preferably, the deicing solution 14 is a liquid solution that does not contain corrosive salts or glycols such that the deicing solution 14 is safe for use on concrete, asphalt, brick, rubber, stone, and wood surfaces. In some embodiments, the deicing solution 14 has a freezing point of about −72° F. (about −58° C.). A pump 16 is in fluid communication with the deicing solution reservoir 12 via tubing 15 and is configured to pump, or distribute, the deicer solution 14. The pump 16 may be, for example, an electrical pump, a pneumatic pump, a hydraulic pump, or a mechanical pump such a belt driven pump, a gear driven pump, an axle driven pump, or a pump driven by air flow caused by a vehicle in motion, etc. One or more emitters 18 are in fluid communication with the deicer solution reservoir 12 and the pump 16 via tubing 15. The emitters 18 are configured to dispense the deicer solution 14 pumped from the deicer solution reservoir 12 onto a surface (e.g., the roof of a structure). Preferably, the emitters 18 are spray emitters (e.g., spray nozzles). In some embodiments, the emitters 18 dispense the deicer solution 14 at a pressure in the range of about 10 psi to about 70 psi. In some embodiments, the emitters 18 dispense the deicer solution 14 at a pressure of about 40 psi. In some embodiments, the emitters 18 dispense the deicer solution 14 at a pressure of less than 40 psi. In some embodiments, the emitters 18 dispense the deicer solution 14 with an angle of deployment in the range of about 30 degrees to about 60 degrees as measured upward from a horizontal plane. In some embodiments, the emitters 18 dispense the deicer solution 14 with an angle of deployment of about 45 degrees as measured upward from the horizontal plane. In some embodiments, the emitters 18 are configured to pivot to dispense the deicer solution 14 with an angle of deployment that is variable in the range of about 30 degrees to about 60 degrees as measured upward from the horizontal plane.

In some embodiments, the emitters 18 are positioned within a housing 20 that is integrally connected to a roof of a structure. For example, as shown in FIG. 1, the emitters 18 are positioned within a rack 20R (e.g., a luggage rack) that is integrally connected to the roof 32 of a vehicle 30, (e.g., an automobile, SUV, a truck, a tractor trailer truck, an off road vehicle, or other motor vehicle). The emitters 18 are configured to spray the deicer solution 14 out through openings 22 in the rack 20R onto the roof 32 of the vehicle 30 to prevent ice from forming thereon while also melting snow accumulations. In some embodiments, the emitters 18 are movable between a dispensing state and a storage state. When in the dispensing state, the emitters 18 are configured to extend out, or pop up, from the openings 22 to spray the deicer solution 14 over the roof 32. When in the storage state, the emitters 18 are configured to retract through the openings 22 for storage within the rack 20R when not in use. The emitters 18 extend/retract through the openings 22 via, for example, resilient members (e.g., springs), biasing units (e.g., mechanically, electronically, or hydraulically driven telescoping or rotating members), fluid pressure within the tubing 15. In some embodiments, the extension/retraction of the emitters 18 is separately controlled, either manually or automatically, by a controller 60. In some embodiments, the extension/retraction of the emitters 18 occurs in direct response to the pressure flow of the deicer solution 14 within the tubing 15. In some embodiments, the emitters 18 are positioned within two racks 20R on opposing edges of the roof 32 to provide better roof coverage of the deicer solution 14. The deicer solution reservoir 12 and the pump 16 may be mounted, for example, under the hood of the vehicle or underneath the vehicle. The tubing 15 may be run throughout the frame of the vehicle 30 and into the rack 20R such that the deicer system 10 is not readily visible when not in use.

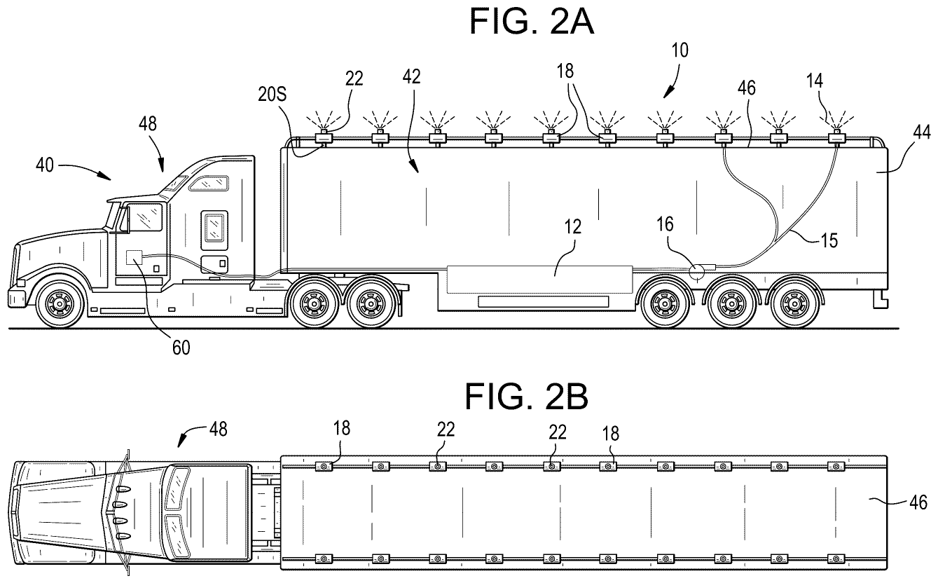

In some embodiments, the emitters 18 are positioned within a housing 20 that is integrally connected to a side of a structure. For example, as shown in FIGS. 2A-2D, the emitters 18 are positioned within a side mount 20S that is integrally connected to a side 44 of a trailer 42 adjacent a peripheral edge of the roof 46 of the trailer 42. The trailer 42 is attached to a truck 40, such as a semi-tractor-trailer truck (i.e., an 18-wheeler truck). The emitters 18 are preferably movable between a dispensing state and a storage state. When in the dispensing state, the emitters 18 are configured to extend out from openings 22 in the side mount 20S to spray the deicer solution 14 onto the roof 46 to prevent ice from forming thereon while also melting snow accumulations. When in the storage state, the emitters 18 are configured to retract through the openings 22 into the side mount 20S such that an uppermost portion of the side mount is substantially flush with the roof 46 when not in use. Thus, the truck 40 can travel under a snow scraper at a Truck Stop without damaging the deicing system 10. The emitters 18 extend/retract through the openings 22 via, for example, resilient members (e.g., springs), biasing units (e.g., mechanically, electronically, or hydraulically driven telescoping or rotating members), fluid pressure within the tubing 15. In some embodiments, the extension/retraction of the emitters 18 is separately controlled, either manually or automatically, by a controller 60. In some embodiments, the extension/retraction of the emitters 18 occurs in direct response to the pressure flow of the deicer solution 14 within the tubing 15. In some embodiments, the emitters 18 are positioned within two side mounts 20S on opposing sides 44 of the trailer 42 to provide better roof coverage of the deicer solution 14. The deicer solution reservoir 12 and the pump 16 may be mounted, for example, behind the cab 48 of the truck 40 or underneath the trailer 42. The tubing 15 may be run throughout the frame of the trailer 42 and into the side mount 20S such that the deicer system 10 is not readily visible when not in use.

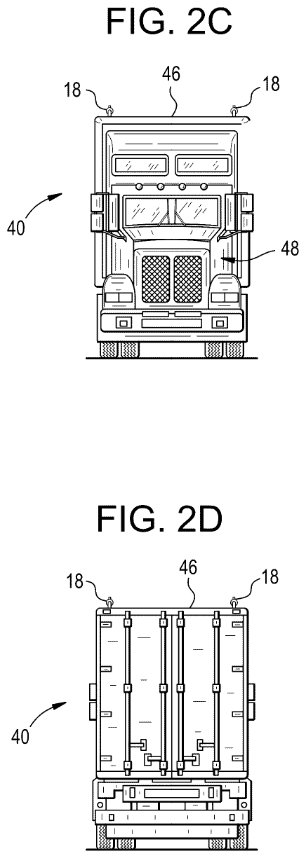

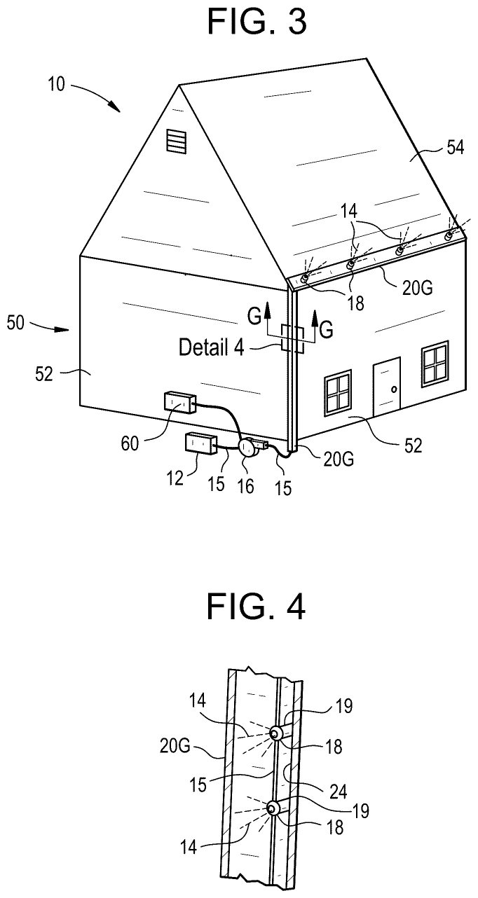

In some embodiments, the emitters 18 are positioned within a housing 20 that is integrally connected to multiple surfaces of a structure. For example, as shown in FIG. 3, the emitters 18 are positioned within a gutter system 20G that is integrally connected to one or more sides 52 and one or more peripheral edges of a roof 54 of a building 50. The emitters 18 are mounted inside the gutter system 20G via mounting members 19 (e.g., brackets, fasteners, etc.) that are attachable to an interior wall 24 of the gutter system 20G, as shown in FIG. 4. As shown in FIG. 3, the emitters 18 are configured to spray the deicer solution 14 within the gutter system 20G and onto the roof 54 to prevent ice from forming and ice damming from occurring. As shown in FIG. 4, the emitters 18 are configured to spray the deicer solution 14 along the interior walls 24 of downspout portions of the gutter system 20G to prevent ice from forming within the gutter system 20G. The deicer solution reservoir 12 and the pump 16 may be installed, for example, in the basement of the building, on or under the ground adjacent the building, or in an adjacent structure, such as a garage. As shown in FIG. 4, the tubing 15 is run throughout the gutter system 20G such that the deicer system 10 is not readily visible when not in use.

In some embodiments, the deicer system 10 includes a controller 60 that is in electrical communication with the pump 16 and is positioned within the structure (e.g., the vehicle 30, the cab 48 of the truck 40, the building 50) such that a user can manually operate the deicer system 10. In some embodiments, the deicer system 10 includes one or more sensors (e.g., temperature sensor, pressure sensor, water sensor, etc.) (not shown) in electrical communication with the controller, which is configured to automatically operate the deicer system 10 when predetermined conditions are detected by the sensors.

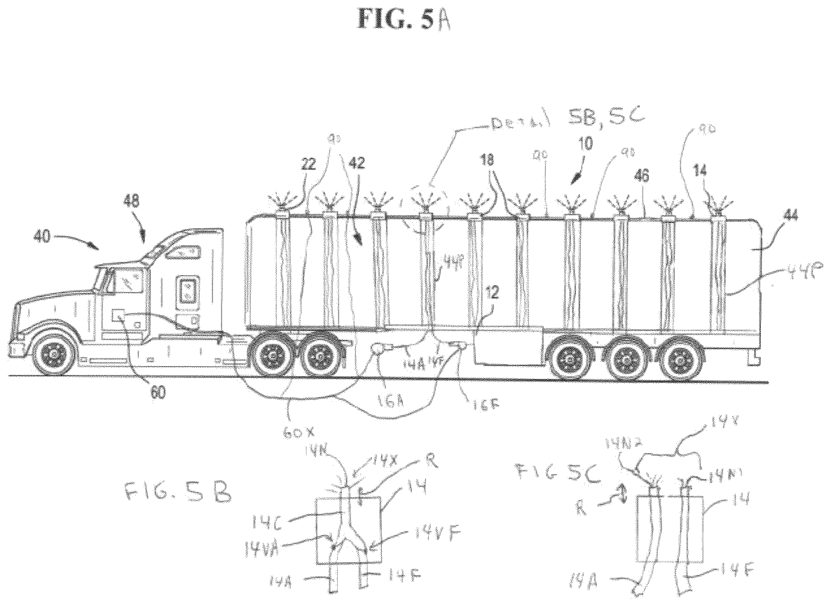

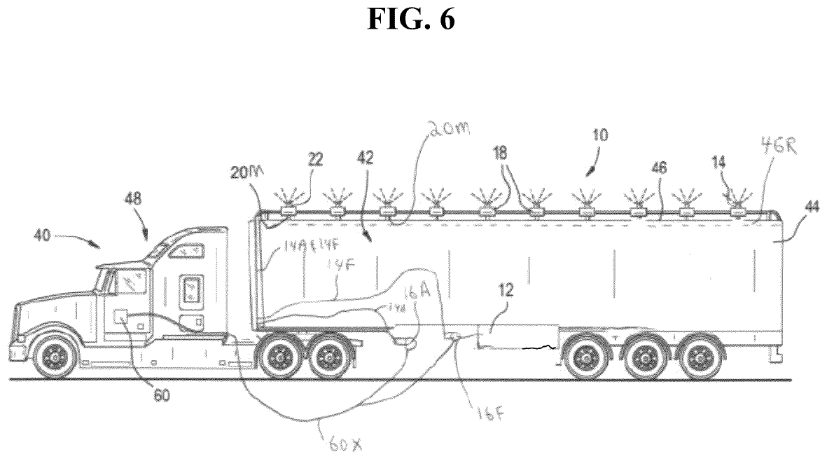

As shown in FIGS. 5A and 6, a system 10 for detecting and removing snow and ice from a roof 46 of a road traveling vehicle 44 (e.g., a trailer) includes a deicing solution reservoir 12 secured to the road traveling vehicle 44. The deicing solution reservoir 12 contains a deicer solution. The system 10 also includes a pump 16F secured to the road traveling vehicle 44 and being in fluid communication with the deicer solution reservoir 12. The pump 16F is configured to distribute the deicer solution. The system 10 includes a gas source 16A (e.g., a compressor or pressurized gas cylinder) secured to the road traveling vehicle 44 and configured to discharge a compressed gas (e.g., air or heated air) therefrom. The system 10 includes an emitter arrangement 14X that is in fluid communication with the deicer solution reservoir 12, the pump 16F and the gas source 16A. The emitter arrangement 14X is retractably mounted in a housing 14 secured to the road traveling vehicle 44. The emitter arrangement 14X is configured to dispense (e.g., selectively discharge) the deicer solution and the compressed gas along the roof 46.

As shown in FIG. 5B, in some embodiments, the emitter arrangement 14X has a single nozzle 14N that is configured to dispense the deicer solution and the compressed gas along the roof 46. The single nozzle 14N is in communication with a common branch 14C of a Y-connector which has a gas branch 14A and a fluid branch 14F that each merge into the common branch 14C. The gas branch 14A has a first check valve 14VA therein and the fluid branch 14F has a second check valve 14VF therein. The gas branch 14A is in communication with the gas source 16A via a first conduit 14A; and the fluid branch 14F is in fluid communication with the pump 16F via a second conduit 14F.

As shown in FIG. 5C, in some embodiments, the emitter arrangement 14X has a first nozzle 14N1 that is configured to dispense the deicer solution along the roof 46 and a second nozzle 14N2 that is configured to dispense the compressed gas along the roof 46. The first nozzle 14N1 is in communication with the gas supply 16A via a first conduit 14A and the second nozzle 14N2 is in communication with the pump 16F via a second conduit 14F. While the first conduit 14A, and the second conduit 14F are shown and described, the present invention is not limited in this regard as a dual port manifold that is integrally formed with the wall post 44P and/or the roof rail 46R may be employed to transport the deicer solution and the gas to the respective nozzle 14N, 14N1, or 14N2.

In some embodiments, the emitter arrangement 14X is configured to pivot relative to the roof 46 and oscillate to sweep an angle horizontally and vertically relative to the roof 46.

In some embodiments, the housing 14 removably secured to roof 46 of the road traveling vehicle 44 along a roof rail 46R via a magnet 20M. Hosing and/or the retractable nozzles 14N, 14N1, 14N2 are magnetic, making this system 10 completely portable. The system 10 can be taken off and put onto another trailer if needed and retrofit on to existing road traveling vehicles 44. The hosing and retractable nozzles 14N, 14N1, 14N2 are placed on the inside of the roof rail 46R (see FIG. 6) that runs along the top of the road traveling vehicle 44. There is enough space to fit the hosing and the nozzles 14N, 14N1, 14N2.

In some embodiments, the housing 14 is fixedly secured proximate the roof 46 of the road traveling vehicle 44 in a wall post 44P of the road traveling vehicle 44.

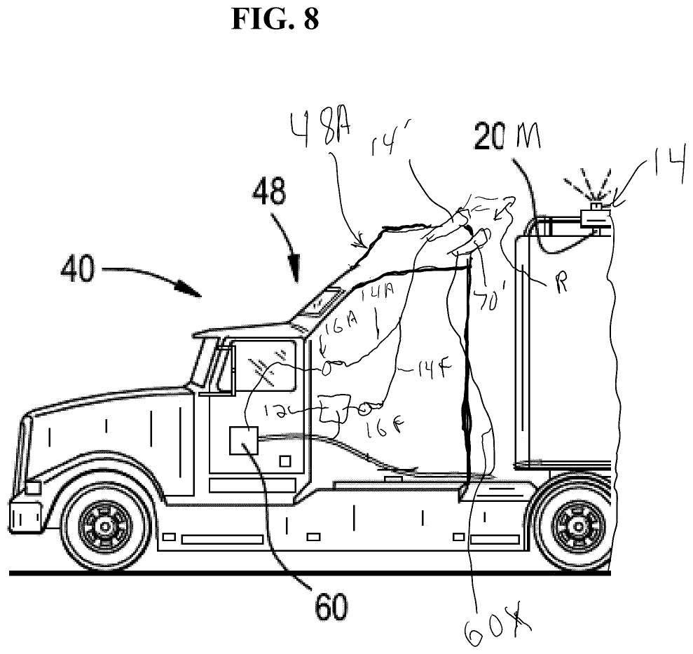

As shown in FIG. 8, in some embodiments, the housing 14′ is fixedly or removably secured to an air deflector 48A attached to a cab 48 of a truck 40 that is configured to tow the road traveling vehicle 44, the housing 14′ is mounted proximate the roof 46 such that the compressed gas and the deicing solution are dischargeable over the roof 46.

In some embodiments, a camera system 70, 70′ is retractably mounted to the roof 46, a wall post 44P of the road traveling vehicle 44, and/or an air deflector 48A attached to a cab 48 of a truck 40 that is configured to tow the road traveling vehicle 44.

In some embodiments, the emitter arrangement 14 is configured to extend outwardly from at least one opening in the housing 14, and over the roof 46 when in a dispensing state, and to retract into the housing 14 through the at least one opening when in a storage state.

In some embodiments, an uppermost portion of the housing 14 is substantially flush with the roof 46 of the vehicle when the emitter is in a storage state.

In some embodiments, the deicer solution is a biodegradable liquid that is non-corrosive to metal materials.

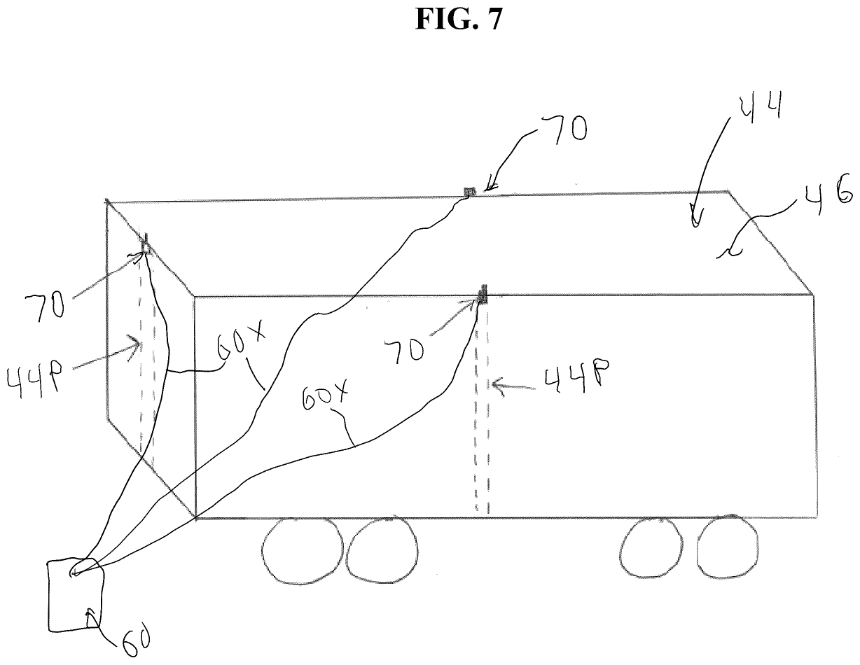

As shown in FIGS. 5A, 6, 7 and 8, in some embodiments, a controller 60 is in communication with the pump 16F, the gas source 16A and the camera system 70, 70′ for automatic control thereof.

As shown in FIG. 5A, for example, a sensor system 90 is mounted proximate or on the roof 46. The sensor system includes a plurality of sensors including but not limited to temperature sensors, and proximity probes configured to measure the depth or presence of snow or ice on the roof. The controller 60 includes an artificial intelligence processing unit that is configured for one or both of machine learning or being trained based upon information received from the sensor system 90 and the camera system 70, 70′. The artificial intelligence processing unit is configured to communicate with a person to automatically report snow and ice conditions on the roof 46 to the person and control the pump 16F and the gas source 16A to mitigate ice and snow accumulation on the roof 46, on a real time basis. For example, the artificial intelligence processing unit is configured to communicate with the person while the person is driving a truck 40 that is towing the road traveling vehicle 44, with the person while the person is in a cab 48 attached to the truck 40, and/or with the person's mobile communication device (e.g., cell phone or i-pad) or computer device. The artificial intelligence processing unit improves the process of operating the system 10 which would be difficult or impossible to do because of the significant height of the road traveling vehicle 44 (e.g., 15 feet or more) that would result in the person not being able to view the roof 46 of the vehicle, In addition, the artificial intelligence processing unit improves the process of operating the system 10 by taking over automatic control of the system for example while the person is driving the truck 40. The artificial intelligence processing unit includes tangible, non-transitory memory for storage of historical data of performance and ability of the system 10 to mitigate and remove ice and snow from the roof and to learn from this historical data to operate the system 10 in the future, depending on the current conditions. The artificial intelligence processing unit determines (and controls) if the deicing solution should be used to melt the ice or snow or if it the gas source should be used to blow the snow off of the roof. The artificial intelligence processing unit also determines and controls the operation of the heat exchange 99 depending on historical data and the operating conditions of the truck 40.

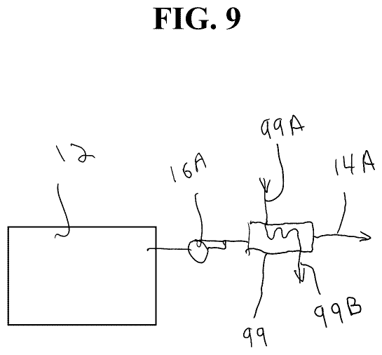

As shown in FIG. 9, in some embodiments, a heat exchanger 99 is in fluid communication with the pump 16F and/or the gas source 16A. The heat exchanger 99 is in communication with an engine coolant system or exhaust system of a truck 40 that is configured to tow the road traveling vehicle 44. The heat exchanger is configured to heat the gas or deicing fluid transported through the heat exchanger 99. In some embodiments, the heat exchanger 99 is located in the storage tank 12 to heat the deicer solution.

Hosing and retractable nozzles 14N, 14N1, 14N2 are built into the walls (e.g., inside wall support posts 44P of the road traveling vehicle 44 (e.g., the trailer). This embodiment has utility in new trailer construction. The posts 44P are steel with an inside channel with adequate space for hosing and retractable nozzles 14N, 14N1, 14N2 at the top, thereby keeping the aesthetic beauty of the trailer. The pump 16F and storage tank 12 are located, for example, underneath the trailer body or in the air deflector 48A.

While the present invention and embodiments disclosed herein and described with reference to FIGS. 5A, 5B, 5C, 6, 7, 8, and 9, for use with road traveling vehicles 44 and truck configured to tow the road traveling vehicle 44, the present invention is not limited in this regard, as the invention may be adapted for use in stationary buildings such as one or more peripheral edges of a roof 54 of a building 50, as shown in FIG. 3.

As shown in FIG. 8, an air deflector for a cab of a truck includes an aerodynamic outer surface 48A that extends from a first mounting flange and the air deflector having an upper mounting flange formed thereon or attached thereto. The air deflector has an equipment compartment located in an interior area thereof. The equipment compartment includes: (a) a deicing solution reservoir 12 secured to the equipment compartment, the deicing solution reservoir containing a deicer solution; (b) a pump 16F secured to the equipment compartment and being in fluid communication with the deicer solution reservoir 12, the pump 16F being configured to distribute the deicer solution; (c) a gas source 16A secured to equipment compartment and configured to discharge a compressed gas therefrom; (d) camera system 70, 70′ retractably mounted to the upper flange; and (e) a controller 60 mounted in the equipment compartment and in communication with the pump 16F, the gas source 16A and the camera system 70′. The air deflector includes an emitter arrangement 14X that is in fluid communication with the deicer solution reservoir 12, the pump 16F and the gas source 16A. The emitter arrangement 14X is retractably mounted in a housing 14 secured to the upper flange. The emitter arrangement 14X is configured to dispense the deicer solution and the compressed gas therefrom. In some embodiments, the air deflector includes a heat exchanger located in an interior area of the air deflector and in communication with at least one of the deicer solution and the gas.

While the present disclosure has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for detecting and removing snow and ice from a roof of a road traveling vehicle, the system comprising:
a deicing solution reservoir secured to the road traveling vehicle, the deicing solution reservoir containing a deicer solution;
a pump secured to the road traveling vehicle and being in fluid communication with the deicer solution reservoir, the pump being configured to distribute the deicer solution;
a gas source secured to the road traveling vehicle and configured to discharge a compressed gas therefrom; and
an emitter arrangement in fluid communication with the deicer solution reservoir, the pump and the gas source, the emitter arrangement is retractably mounted in a housing secured to the road traveling vehicle, the emitter arrangement is configured to dispense the deicer solution and the compressed gas along the roof.

2. The system of claim 1, wherein the emitter arrangement comprises a single nozzle that is configured to dispense the deicer solution and the compressed gas along the roof.

3. The system of claim 1, wherein the single nozzle is in communication with a common branch of a Y-connector which has a gas branch and a fluid branch that each merge into the common branch;
the gas branch having a first check valve therein and the fluid branch having a second check valve therein;
the gas branch being in communication with the gas source via a first conduit; and
the fluid branch being in fluid communication with the pump via a second conduit.

4. The system of claim 1, wherein the emitter arrangement comprises a first nozzle that is configured to dispense the deicer solution along the roof and a second nozzle that is configured to dispense the compressed gas along the roof.

5. The system of claim 4, wherein the first nozzle is in communication with the gas supply via a first conduit and the second nozzle is in communication with the pump via a second conduit.

6. The system of claim 1, wherein the emitter arrangement is configured to pivot relative to the roof and oscillate to sweep an angle horizontally and vertically relative to the roof.

7. The system of claim 1, wherein the housing removably secured to roof of the road traveling vehicle along a roof rail via a magnet.

8. The system of claim 1, wherein the housing is fixedly secured proximate the roof of the road traveling vehicle in a wall post of the road traveling vehicle.

9. The system of claim 1, wherein the housing is fixedly or removably secured to an air deflector attached to a cab of a truck that is configured to tow the road traveling vehicle proximate the roof such that the compressed gas and the deicing solution are dischargeable over the roof.

10. The system of claim 1, further comprising a camera system retractably mounted to at least one of the roof, a wall post of the road traveling vehicle, and an air deflector attached to a cab of a truck that is configured to tow the road traveling vehicle.

11. The system of claim 1, wherein the emitter arrangement is configured to extend out from at least one opening in the housing, and over the roof when in a dispensing state, and to retract into the housing through the at least one opening when in a storage state.

12. The system of claim 1, wherein an uppermost portion of the housing is substantially flush with the roof of the vehicle when the emitter is in a storage state.

13. The system of claim 1, wherein the deicer solution comprises a biodegradable liquid that is non-corrosive to metal materials.

14. The system of claim 1, further comprising a controller in communication with the pump, the gas source and the camera system for automatic control thereof.

15. The system of claim 14, further comprising a sensor system mounted proximate or on the roof;
the controller comprising an artificial intelligence processing unit configured for one or both of machine learning or being trained based upon information received from the sensor system and the camera system;
wherein the artificial intelligence processing unit is configured to communicate with a person to automatically report snow and ice conditions on the roof to the person and control the pump and the gas source to mitigate ice and snow accumulation on the roof, on a real time basis.

16. The system of claim 1, further comprising a heat exchanger that is in fluid communication with the pump or the gas source, the heat exchanger is in communication with at least one of an engine coolant system or exhaust system of a truck that is configured to tow the road traveling vehicle, the heat exchanger being configured to heat the gas or deicing fluid transported through the heat exchanger.

17. An air deflector for a cab of a truck; the air deflector comprising:
an aerodynamic outer surface extending from a first mounting flange and the air deflector having an upper mounting flange formed thereon or attached thereto;
an equipment compartment comprising:
(a) a deicing solution reservoir secured to the equipment compartment, the deicing solution reservoir containing a deicer solution;
(b) a pump secured to the equipment compartment and being in fluid communication with the deicer solution reservoir, the pump being configured to distribute the deicer solution;
(c) a gas source secured to equipment compartment and configured to discharge a compressed gas therefrom;
(d) camera system retractably mounted to the upper flange; and
(e) a controller mounted in the equipment compartment and in communication with the pump, the gas source and the camera system; and
an emitter arrangement in fluid communication with the deicer solution reservoir, the pump and the gas source, the emitter arrangement is retractably mounted in a housing secured to the upper flange, the emitter arrangement is configured to dispense the deicer solution and the compressed gas therefrom.

18. The air deflector of claim 17, further comprising a heat exchanger located in an interior area of the air deflector and in communication with at least one of the deicer solution and the gas.
